(19) United States
(12) Patent Application Publication
(10) Pub. No.: US 2010/0030737 A1
(43) Pub. Date: Feb. 4, 2010

(54) IDENTITY ENABLED DATA LEVEL ACCESS CONTROL

(76) Inventors: Volker Gunnar Scheuber-Heinz, Pleasant Grove, UT (US); Lynn Crabb, Lindon, UT (US); Stephen R. Carter, Spanish Fork, UT (US); David Kent Beus, Highland, UT (US); Thomas Becker, Toenisvorst (DE); Jed Rampton, Lehi, UT (US); Kevin Marinus Boogert, Sandy, UT (US); Michael William Cook, Cedar Hills, UT (US)

Correspondence Address: SCHWEGMAN, LUNDBERG & WOESSNER/NOVELL, PO BOX 2938, MINNEAPOLIS, MN, 55402, US

(21) Appl. No.: 12/181,939

(22) Filed: Jul. 29, 2008

(51) Int. Cl. G06F 17/30

(52) U.S. Cl. 707/3; 707/9; 707/E17.014

(57) ABSTRACT

Mechanisms for identity enabled data level access control are provided. Data queries from principals are intercepted and access rights are assigned in response to identities associated with the principals. The access rights are enforced by modifying the queries and/or filtering results from the queries. The modified queries and/or filtered results are processed against a data store on behalf of the principals and returned to the principals.

### BACKGROUND

Increasingly enterprises are demanding reports about enterprise data and demanding access to enterprise information housed mainly in relational databases. This is particularly useful at the executive levels of enterprises but is also very much used at the lowest levels of the enterprise for planning and conducting business on a daily basis.

One issue with relational databases is the inability to effectively control record level or attribute level access to database tables. So, usually one has access to a database table as a whole or has no access at all. There are mechanisms that alleviate this situation somewhat. For example, in the case of report generation; generally, reporting tools are provided that execute user-defined queries against one or more databases. The reporting tools enforce security by manually inserting Structured Query Language (SQL) “WHERE” conditions to achieve a desired security. Essentially, query conditions are manually added to report queries for achieving security.

If somehow the query produced by a report tool is compromised and assuming someone has access to a database or can acquire the query, then the WHERE clauses could be redacted and security could be breached.

Another common approach is to explicitly create “views” in the database, which are virtual tables defined by SQL queries, and then basing the report queries on these views. Views are usually created manually and access rights for the views are setup to the views themselves instead of the actual tables. Furthermore, since views are defined using SQL queries they only provide their specified subset or transformation of the data. To provide different levels of security, multiple views must be created beforehand and managed. If security is to be user-specific, for instance, the number of distinct views required could be impractical for more than a small number of users.

So, many enterprises employ specialized staff whose sole job is to determine the WHERE clauses for report queries and implement these WHERE clauses within the enterprises' reporting tools or separately created views. This is a laborious exercise that is fraught with potential error and with bottlenecks and can also often delay creation of needed reports within an enterprise. Furthermore, there is also no real consistency in this approach because the security for the reports is often maintained and managed by the specialized staff in a manner that is separate and is largely not integrated with an enterprise's overall security policies.

Thus, improved mechanisms are needed for achieving fine-grain security with database access attempts and with database report generation.

### SUMMARY

In various embodiments, mechanisms for achieving identity-enabled data level access control within a database environment are provided. More specifically, and in an embodiment, a method is provided for identity enabled data level access. A query is received from a principal for access to an enterprise data store. An identity for the principal is resolved and access rights are acquired for the enterprise data store in response to the identity of the principal. The query is automatically modified for purposes of enforcing the access rights and in a manner that is entirely unbeknownst to the principal. Next, the modified query is executed against the enterprise data store and results are returned to the principal in response to executing the modified query.

### BRIEF DESCRIPTION OF THE DRAWINGS

FIG. 1 is a diagram of a method for identity enabled data level access, according to an example embodiment.

FIG. 2 is a diagram of another method for identity enabled data level access, according to an example embodiment.

FIG. 3 is a diagram of an identity enabled data level access system, according to an example embodiment.

FIG. 4 is a diagram of another identity enabled data level access system, according to an example embodiment.

### DETAILED DESCRIPTION

A “resource” may include a user, content, a processing device, a node, a service, an application, a system, a schema definition, a directory, an operating system (OS), a file system, a data store, a database, a policy definition, a configuration definition, a file, a World-Wide Web (WWW) service, a WWW page, groups of users, combinations of these things, etc. The terms “service,” “application,” and “system” may be used interchangeably herein and refer to a type of software resource that includes instructions, which when executed by a machine performs operations that change the state of the machine and that may produce output.

A “principal” is a specific type of resource, such as a user or an automated service that is uniquely identified via an identity assigned after proper authentication. The identity is an electronic identifier that unique identifies a particular principal within a given processing context.

A “data store” as used herein refers to a relational database, a data warehouse organized as an interface to collection or relational databases, a directory, a lightweight directory access protocol (LDAP) database, and/or various combinations of these things.

Various embodiments of this invention can be implemented in existing network architectures, operating systems, security systems, proxies, authentication services, database interfaces, data centers, and/or communication devices. Any particular architectural layout or implementation presented herein is provided for purposes of illustration and comprehension only and is not intended to limit aspects or embodiments of the invention.

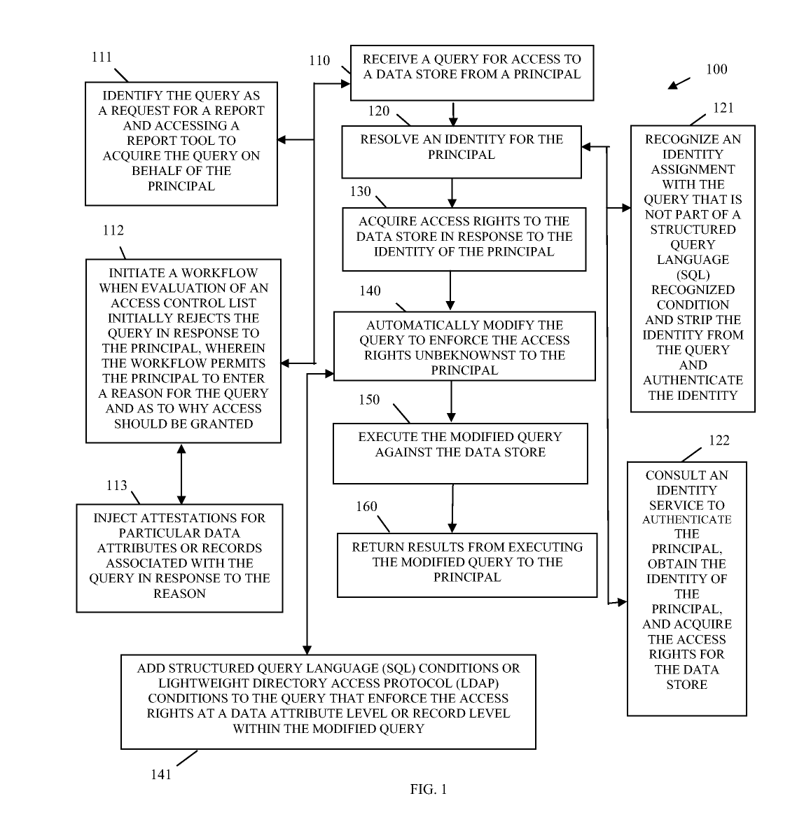

It is within this context, that various embodiments of the invention are now presented with reference to the FIGS. 1-4.

FIG. 1 is a diagram of a method 100 for identity enabled data level access, according to an example embodiment. The method 100 (hereinafter “fine-grain data access security service”) is implemented as instructions in a machine-accessible and readable medium. The instructions when executed by a machine (processor and memory enabled device, such as a computer, etc.) perform the processing depicted in the FIG. 1. The fine-grain data access security service is also operational over and processes within a network. The network may be wired, wireless, or a combination of wired and wireless.

As will be more fully described herein and below, the fine-grain data access security service permits data store access to be transparently modified to enforce identity-based security on a fine-grain data access level of detail.

At 110, the fine-grain data access security service receives a query for access to a data store from a principal.

In an embodiment, the principal is a user that is requesting that a report tool process a report. The report is a query that is to process against a data warehouse, which is the data store and which is an interface to a plurality of enterprise relational databases. Some of the relational databases are different from one another, such as Oracle®, DB2®, Microsoft SQL Server®, Sybase®, etc.

Conventionally, an enterprise would enforce security that it desired via modifications to the report tools that generate report queries or by creating various views in their databases. This was done manually and was time consuming and not very flexible. As will be more fully demonstrated herein and below, security enforcement can be achieved in a more robust and portable manner without modifying legacy services or report tools.

So, according to an embodiment, at 111, the fine-grain data access security service identifies the query as a specific request for a report. In response to this, the fine-grain data access security service accesses a report tool and acquires the query associated with the desired report on behalf of the principal. In this arrangement, the fine-grain data access security service may be viewed as a proxy that sits in between the principal and the report tool. In other cases, the fine-grain data access security service may sit in between the report tool and the data store (such as a data warehouse as was discussed above).

In another case, at 112, the fine-grain data access security service initiates a workflow evaluation of an access control list when the query is initially rejected based on initial security rights associated with the requesting principal. Processes of the workflow then engage the principal to enter a reason or rationale for the query being requested and as to why the principal believes access should be granted when the access control indicates access should not be granted. This processing permits exception processing to be achieved in cases where it is warranted. For example, the principal may be engaged in an enterprise due diligence effort to purchase another enterprise and typical access that would normally be denied to a particular employee may now be warranted. It may also be that security trading, which was previously blacked out, is now permissible. In fact, a variety of reasons can exist that policy may permit when the principal supplies a reason or rationale that is evaluated by the workflow processes in view of the policy. This automated exception processing was completely devoid in the conventional approaches and had to be achieved, if at all, in a purely manual fashion by an enterprise.

It is noted that the processing associated with 112 in some cases may rely on the fact that an identity of the principal has been resolved and authenticated. Thus, the FIG. 1 is not intended to impart any specific or limiting processing order and is presented for purposes of illustration only.

Continuing with the embodiment at 112 and at 113, the fine-grain data access security service injects attestations for particular data attributes (relational database fields, etc.) or for particular records. The attestations are carried as security metadata with the query and are obtained in view of policy evaluation in response to the reason supplied by the principal as to why a particular exception to normal security should be granted.

At 120, the fine-grain data access security service resolves an identity for the principal that makes the query or data access request. This can be achieved in a variety of manners.

For example, at 121, the fine-grain data access security service recognizes a particular identity assignment with the query. The identity assignment is set in the query using a modified or extended version of SQL. That is, the identity assignment is an SQL condition placed in the query. Legacy SQL search services do not recognize this extended SQL condition. So, the fine-grain data access security service strips the identity condition from the query and then proceeds to authenticate the identity to ensure it is valid. The principal may have included the SQL identity condition or another automated service, such as a policy decision point (PDP) service may have added it on behalf of the principal and in a manner that is transparent and unknown to the principal.

In another case, at 122, the fine-grain data access security service consults an identity service to authenticate the principal and obtain the identity assignment that is to be associated with the principal. The identity can then be used to acquire the access rights for access to the data store.

At 130, the fine-grain data access security service acquires access rights to the data store in response to the identity of the principal. This can also be done in a variety of manners and via automated consultation with a variety of third-party services, such as PDP's, identity managers, authentication services, policy services, etc.

At 140, the fine-grain data access security service automatically modify the query to enforce the access rights and in a manner that is unbeknownst to the principal. In other words, the principal does not realize that the fine-grain and identity-based security is being enforced via the access rights. In fact, the principal may be entirely unaware of the processing that the fine-grain data access security service performs. This can occur when the fine-grain data access security service is configured and processed as a transparent or reverse proxy. It is noted, that in some cases the principal may be aware and in these cases the fine-grain data access security service can be configured as a forward proxy.

According to an embodiment, at 141, the fine-grain data access security service modifies the query by adding SQL conditions or even LDAP conditions to the query that are designed to achieve the desired access rights at a data attribute (field) or record level of detail within the modified query. This can be done via additions of WHERE SQL conditions to the query. It is noted that this is done via the fine-grain data access security service and not via a legacy report tool that has been traditionally used. Moreover, this is done in a purely automated fashion by an automated process namely the fine-grain data access security service and not via a manual modification to a report query, which is the convention technique.

At 150, the fine-grain data access security service executes the modified query against the data store. The modified query includes data access language (such as SQL or LDAP) statements that enforce the access rights. This is done before the query is processed against the data store. Conventionally, the manual conditions were done after the query processed as a filter, which means the data was in fact accessed, which may in and of itself create government compliance issues or violate privacy laws, even if the confidential data is never actually presented to a user. With the techniques presented herein, the data that is not to be accessed based on the access rights are not accessed in the first instance, since the fine-grain data access security service modifies the query before it processed against the data store.

Finally, at 160, the fine-grain data access security service returns the results from executing the modified query to the principal to satisfy the principal's initial query request.

It is now appreciated how the fine-grain data access security service can be injected into a process flow associated with accessing a data store and how enterprise security can be enforced based on identity at a fine-grain level of data access. This is done without modifying legacy data access languages or tools. So, the fine-grain data access security service can be integrated and processed in manners that require no modifications to legacy enterprises services and can incorporate and enforce enterprise security at fine-grain levels of detail against data access attempts on enterprise data assets.

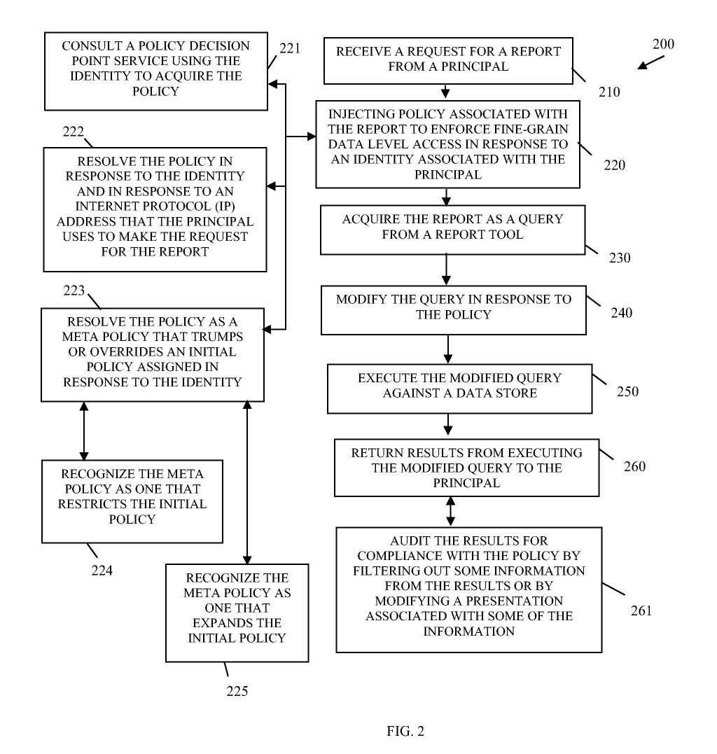

FIG. 2 is a diagram of another method 200 for identity enabled data level access, according to an example embodiment. The method 200 (hereinafter “identity enabled data access enforcement service”) is implemented as instructions in a machine-accessible and readable medium. The instructions when executed by a machine perform the processing depicted in the FIG. 2. The identity enabled data access enforcement service is also operational over and processes within a network. The network may be wired, wireless, or a combination of wired and wireless.

The identity enabled data access enforcement service represents a different perspective and in some cases enhanced perspective of the fine-grain data access security service represented by the method 100 of the FIG. 1.

At 210, the identity enabled data access enforcement service receives a request for report from a principal. Again, the principal may be a user or an automated service or application that processes within an enterprise. The principal directs the request for the report to a legacy enterprise report tool and the desire of the principal is to access information housed in an enterprise's data warehouse or directory.

At 220, the identity enabled data access enforcement service injects policy that is to be associated with the report into the request flow for the report. This policy is directed to enforcing fine-grain data level access in response to an identity associated with or assigned to the requesting principal. The policy can be obtained in a variety of manners and can be varying degrees of complexity.

For example, at 221, the identity enabled data access enforcement service consults a PDP service using the identity of the principal to acquire the policy. So, a PDP service used by an enterprise for other enterprise security can be leveraged and used to supply the policy in an automated fashion to the identity enabled data access enforcement service when a principal attempts to access information assets of the enterprise. The PDP service supplies a consistent enterprise policy based on the principal's resolved identity.

In another case, at 222, the identity enabled data access enforcement service resolves the policy in response to the identity and in response to an Internet Protocol (IP) address for the principal that the principal used to make the request for the report. So, policy may change when a principal with a particular identity is attempt to get a report from an external or particular device that the enterprise may not view as being secure. This situation can be accounted from in the policy assignment and one mechanism for doing this is to use the IP address of the requesting principal in combination with the identity of the principal when the policy is assigned.

In yet another situation, at 223, the identity enabled data access enforcement service resolves the policy as a meta policy that trumps or actually partially or completely overrides an initial policy assigned in response to the identity. So, the policy assignment mechanism can be hierarchical in nature and conditions and/or events present when the report request is received can drive which policy is to take precedence. Thus, assignment of policy is not binary it can be more complex.

As an example, at 224, the identity enabled data access enforcement service recognizes the meta policy as one that restricts the initially assigned policy such that decreased access rights are granted from what would typically be permitted.

In an alternative situation, at 225, the identity enabled data access enforcement service recognizes the meta policy as one that expands the initially assigned policy so as to grant more or enhanced access rights from what would typically be permitted.

At 230, the identity enabled data access enforcement service acquires the report as a query from a report tool. That is, the query the principal makes the request for the report and directs the request to a legacy report tool. The identity enabled data access enforcement service intercepts that request and injects the policy, as discussed above. The policy translates to specific access rights. The report tool receives the request and then generates a query that will produce the report that the principal wants to see.

But before the query is processed, at 240, the identity enabled data access enforcement service modifies the query in response to the policy assignment made and injected into the process flow of the principal's report request at 220.

At 250, the identity enabled data access enforcement service executes the modified query against the data store and the modification is done in such a way that the access rights defined by the policy are enforced before the modified query is processed against the data store.

At 260, the identity enabled data access enforcement service returns results from executing the modified query against the data store to the principal. Now, the principal has the data requested by only the data that the principal is entitled to have. Note that this was achieved without injecting manual conditions into the query via an administrator that modifies the legacy report tool. Note also that this was done to utilize an enterprise's existing security services and tools.

According to an embodiment, at 261, the identity enabled data access enforcement service can also audit the results for further compliance with the policy or with new policy that may have been dynamically injected into the enterprise after the query was executed and before the results are presented to the principal. Here, the identity enabled data access enforcement service can take a variety of filtering actions such as removing data fields, records, and/or attributes entirely from the results, such that the principal is totally unaware that they existed in the first place. In other cases, the identity enabled data access enforcement service can X out data from the results, such that the principal is aware that data was blocked from the principal's view based on security compliance. In this latter situation, the principal may go through the proper channels or through exception processing (discussed above with reference to the method 100 of the FIG. 1) to perhaps obtain authorization to received the data that was X'd out of the results; since in the latter case the principal is aware that data was redacted out of the results presented to the principal. So information can be redacted or filtered out of the results and/or the presentation associated with the results can be modified.

Thus, fine-grain identity access level enforcement can be achieved pre-query or post-query (via filtering) and/or both pre-query and post-query.

FIG. 3 is a diagram of an identity enabled data level access system 300, according to an example embodiment. The identity enabled data level access system 300 is implemented as instructions on or within a computer-readable storage medium and a machine-accessible and readable medium. The instructions when executed by a machine (computer, etc.) can perform various aspects of the processing depicted with respect to the method 100 of the FIG. 1 and the method 200 of the FIG. 2. The identity enabled data level access system 300 is also operational over a network and the network may be wired, wireless, or a combination of wired and wireless.

The identity enabled data level access system 300 includes a proxy 301 and a data store 302. Each of these components and their interactions with one another will now be discussed in turn.

The proxy 301 is implemented in a machine-accessible and computer-readable storage medium and is to process on a machine of the network. Example processing associated with the proxy was described in detail above with reference to the methods 100 and 200 of the FIGS. 1 and 2, respectively.

During operation of the system 300, a principal attempts to access a report tool to have a report processed against a data store 302. The report is processed as a first query against the data store 302. The proxy 301 resolves an identity for the principal and assigns access rights in response to that assigned identity.

Next, the proxy 301 executes the query against the data store 302 to acquire initial results for the principal. The proxy 301 then automatically generates a second query that is processed against the results or used as a filtering mechanism against the results. The second query is for ensuring that the access rights are properly accounted for and represented in the second query. That is, the second query enforces data attribute or record level access security. The proxy 301 then executes the second query against the results and returns modified results to the principal. Again, the modified results enforce the access rights at the data attribute or record level.

According to an embodiment, the proxy 301 automatically generates the second query by using policy that instructs the proxy 301 on how to automatically add SQL WHERE conditions or LDAP conditions into the second query to enforce the access rights against the initial returned results.

In another situation, the proxy 301 further audits the modified results for additional compliance with the access rights before returning the modified results to the principal. So, a dual-level check can be done to ensure that nothing inadvertently slips through and is visible to the principal that should not be visible to the principal.

In an embodiment, the proxy 301 consults a PDP service to acquire the access rights in response to the identity of the principal. So, the proxy 301 can offload the assignment of the access rights to existing enterprise third-party PDP services. This provides a consistent security view for an enterprise that accounts for data access on an identity basis.

The data store 302 is implemented in a machine-accessible and computer-readable storage medium and is accessible to the proxy 301.

In an embodiment, the data store 302 is a LDAP database. In another case, the data store 302 is a relational database or even a data warehouse that acts as an interface to a plurality of relational databases, some of which may be disparate from other of the relational databases.

The proxy 301 permits an enterprise to house its data assets in any manner it chooses and to integrate enterprise security against access to those data assets utilizes existing enterprise identity-based access control. This is done in an automated fashion. The proxy 301 can be a transparent proxy, a reverse proxy, and if desired or necessitated a forward proxy in some embodiments.

It is also noted that unlike the discussion presented with FIGS. 1 and 2, the proxy 301 can enforce identity-based security at the data attribute level and record level of detail in a post-query fashion. That is, the principal's report can process in a normal fashion against the data store 302 and the proxy 301 intercepts the results returned with the report and then filters (by way of the second automatically-generated query) those results to enforce the fine-grain security that is needed based on policy associated with the identity of the principal.

A combination approach can also be used with the teachings presented herein, such that fine-grain identity-based security is enforced, via modified queries issued or caused to be issued by a principal (by way of report requests), in a pre-query fashion and fine-grain identity-based security is also enforced in a post query fashion (by way of filtering) against results returned from initial query processing.

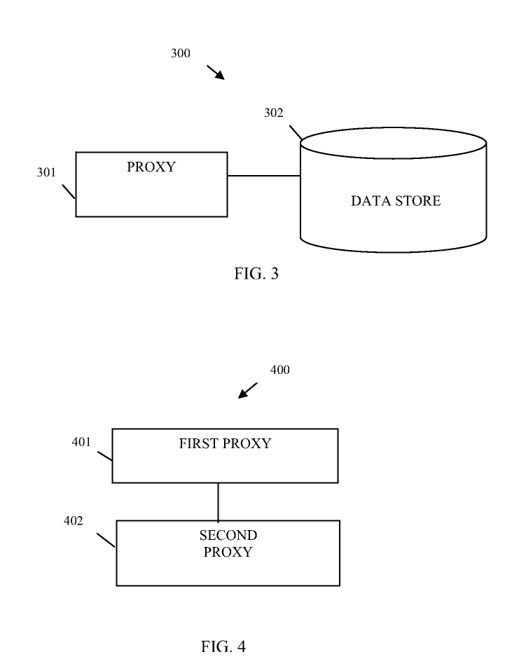

FIG. 4 is a diagram of another identity enabled data level access system 400, according to an example embodiment. The identity enabled data level access system 400 is implemented as instructions on or within a machine-accessible and computer-readable storage medium. The instructions when executed by a machine (such as a computer) perform various aspects of the processing depicted with respect to the methods 100 and 200 of the FIGS. 1 and 2, respectively, and processing associated with the system 300 of the FIG. 3. The identity enabled data level access system 400 is also operational over a network and the network may be wired, wireless, or a combination of wired and wireless.

The identity enabled data level access system 400 includes a first proxy 401 and a second proxy 402. Each of these components and their interactions with one another will now be discussed in turn.

The first proxy 401 is implemented in a machine-accessible and computer-readable storage medium and is to process on a machine of the network.

The first proxy 401 intercepts attempts by a principal to access a report tool of an enterprise and injects policy that is to be associated with a report being requested of the report tool by the principal.

The policy resolves to access rights that are passed to the second proxy 302.

According to an embodiment, the policy can be used to enhance initial access rights assigned in response to an identity of the principal when predefined conditions are met.

In another case, the policy can be used to restrict initial access rights assigned in response to an identity of the principal when predefined conditions are met.

The second proxy 402 is implemented in a machine-accessible and computer-readable storage medium and is to process on the same machine as the first proxy 401 or on a different machine of the network. Example processing associated with the second proxy 402 was described in detail above with reference to the methods 100 and 200 of the FIGS. 1 and 2, respectively and with respect to the system 300 of the FIG. 3.

The second proxy 402 enforces the access rights by modifying a query associated with the report before the modified query is processed against an enterprise data store. The details of this were discussed in detail above with reference to the methods 100 and 200 of the FIGS. 1 and 2, respectively, and with respect to the system 300 of the FIG. 3.

The second proxy 402 can use the resolved access rights as is or the second proxy 402 can augment the access rights by adding or subtracting from the access rights.

According to an embodiment, a second principal bypasses the first proxy 401 and issues a request for a second report via the report tool. The second proxy 402 detects this condition when the report tool attempts to process the second report against the data store. In response, the second proxy 402 injects other access rights that are enforced by modifying a second query associated with the second report before the modified second query is executed against the data store. So, the process flow cannot be circumvented by principals because the second proxy 402 sits in between the report tool and the data store and will not allow the report tool to process report queries directly against the data store. Conversely, the first proxy 401 sits in between the requesting principals and the report tool.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

The Abstract is provided to comply with 37 C.F.R. §1.72(b) and will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A machine-implemented method for identity level data access, comprising:
receiving a query for access to a data store from a principal;
resolving an identity for the principal;
acquiring access rights to the data store in response to the identity of the principal;
automatically modifying the query to enforce the access rights;
executing the modified query against the data store; and
returning results from executing the modified query to the principal.

2. The method of claim 1, wherein receiving further includes identifying the query as a request for a report and accessing a report tool to acquire the query on behalf of the principal.

3. The method of claim 1, wherein receiving further includes initiating a workflow when evaluation of an access control list initially rejects the query in response to the principal, wherein the workflow permits the principal to enter a reason for the query and as to why access should be granted.

4. The method of claim 3, wherein initiating further includes injecting attestations for particular data attributes or records associated with the query in response to the reason.

5. The method of claim 1, wherein resolving further includes recognizing an identity assignment with the query that is not part of a structured query language (SQL) recognized condition and stripping the identity from the query and authenticating the identity.

6. The method of claim 1, wherein resolving further includes consulting an identity service to authenticate the principal, obtain the identity of the principal, and acquire the access rights for the data store.

7. The method of claim 1, wherein automatically modifying further includes adding structured query language (SQL) conditions or Lightweight Directory Access Protocol (LDAP) conditions to the query that enforce the access rights at a data attribute level or record level within the modified query.

8. A machine-implemented method, comprising:
receiving a request for a report from a principal;
injecting policy associated with the report in response to an identity associated with the principal;
acquiring the report as a query from a report tool;
modifying the query in response to the policy;
executing the modified query against a data store; and
returning results from executing the modified query to the principal.

9. The method of claim 8, wherein injecting further includes consulting a policy decision point service using the identity to acquire the policy.

10. The method of claim 8, wherein injecting further includes resolving the policy in response to the identity and in response to an Internet Protocol (IP) address that the principal uses to make the request for the report.

11. The method of claim 8, wherein injecting further includes resolving the policy as a meta policy that trumps or overrides an initial policy assigned in response to the identity.

12. The method of claim 11, wherein resolving further includes recognizing the meta policy as one that restricts the initial policy.

13. The method of claim 11, wherein resolving further includes recognizing the meta policy as one that expands the initial policy.

14. The method of claim 8, wherein returning further includes auditing the results for compliance with the policy by filtering out some information from the results or by modifying a presentation associated with some of the information.

15. A machine-implemented system, comprising:
a proxy implemented in a machine-accessible and computer-readable storage medium that processes on a machine of a network; and
a data store implemented in a machine-accessible and computer-readable storage medium that is accessed by the proxy;
wherein a principal attempts to access a report tool to process a report as a first query against the data store and the proxy resolves an identity for the principal and assigns access rights in response to the identity and then processes an automatically generated second query against results returned from the first query to enforce the access rights at a data attribute or record level of access, and the proxy returns modified results to the principal in response to processing the second query.

16. The system of claim 15, wherein the data store is a lightweight directory access protocol LDAP database.

17. The system of claim 15, wherein the data store is a relational database or a data warehouse that interfaces to a plurality of relational databases.

18. The system of claim 15, wherein the proxy generates the second query by using policy that instructs the proxy on how to add structured query language (SQL) WHERE conditions or Lightweight Directory Access Protocol (LDAP) conditions into the second query to enforce the access rights against the results.

19. The system of claim 15, wherein the proxy audits the modified results for additional compliance with the access rights before returning the modified results to the principal.

20. The system of claim 15, wherein the proxy consults a policy decision point service to acquire the access rights in response to the identity for the principal.

21. A machine-implemented system, comprising:
a first proxy implemented in a machine-accessible and computer-readable storage medium and that processes on a machine of the network; and
a second proxy implemented in a machine-accessible and computer-readable storage medium and that processes on the machine or a different machine of the network;
wherein the first proxy intercepts attempts by a principal to access a report tool of an enterprise and injects policy that is to be associated with a report being requested of the report tool by the principal, the policy resolves to access rights that are passed to the second proxy, wherein the second proxy can use the access rights as resolved or can augment the access rights by adding or subtracting, and the second proxy enforces the access rights by modifying a query associated with the report before the modified query is processed against a data store.

22. The system of claim 21, wherein the second proxy audits results returned from executing the modified query to ensure the access rights were properly enforced.

23. The system of claim 21, wherein the policy can enhance initial access rights assigned in response to an identity of the principal when predefined conditions are met.

24. The system of claim 21, wherein the policy can restrict initial access rights assigned in response to an identity of the principal when predefined conditions are met.

25. The system of claim 21, wherein a second principal bypasses the first proxy and issues a request for a second report via the report tool, and wherein the second proxy detects this condition when the report tool attempts to process the second report against the data store and the second proxy injects other access rights that are enforced by modifying a second query associated with the second report before the modified second query is executed against the data store.
